(19) United States
(12) Patent Application Publication
(10) Pub. No.: US 2023/0039240 A1
(43) Pub. Date: Feb. 9, 2023

(54) FUEL LUBRICITY ADDITIVE

(71) Applicant: TOTALENERGIES ONETECH, Courbevoie (FR)

(72) Inventor: Thomas DUBOIS, Solaize (FR)

(73) Assignee: TOTALENERGIES ONETECH, Courbevoie (FR)

(21) Appl. No.: 17/779,440

(22) PCT Filed: Nov. 20, 2020
(86) PCT No.: PCT/EP2020/082976

§ 371 Date: May 24, 2022

(30) Foreign Application Priority Data
Nov. 25, 2019 (FR) 1913156

(51) Int. Cl. C10L 10/08; C10L 1/18; C10L 1/182; C10L 1/19

(52) U.S. Cl. CPC C10L 10/08; C10L 1/1802; C10L 1/1824; C10L 1/19; C10L 2200/0423; C10L 2200/0446

(57) ABSTRACT

The present invention relates to a fuel composition, in particular for an internal combustion engine, comprising: (1) at least one liquid hydrocarbon cut from one or more sources selected from the group consisting of mineral, animal, plant and synthetic sources, and (2) from 1 to 10,000 ppm by weight of an additive which comprises at least 6% by weight of free sterols and/or sterol esters and from 70% to 94% by weight of free fatty acids, these contents being expressed in relation to the total weight of the additive. The present invention also relates to the use of such an additive for improving the lubricity properties of an engine fuel.

The present invention relates to a fuel composition which comprises a particular additive for engine fuel, in particular for diesel or gasoline fuel. The additive comprises at least 6% by weight of total sterols (free sterols and/or sterol esters) and from 70% to 94% by weight of free fatty acids, these contents being expressed in relation to the total weight of the additive.

The additive according to the invention is more particularly intended for fuels for engines, preferably internal combustion engines, having a low sulphur content, for example less than 500 ppm by weight, preferably less than 10 ppm by weight, and wherein it has good lubricity properties.

The invention also relates to the use, to improve the lubricity properties of an engine fuel, of an additive which comprises at least 6% by weight of compounds selected from free sterols and/or sterol esters and 70% to 94% by weight of free fatty acids, these contents being expressed in relation to the total weight of the additive.

### PRIOR ART

In order to limit the release of polluting emissions, many regulations impose relatively low sulphur compound contents in fuels, gasoline and gas oils. To this end, the hydrocarbons used for the manufacture of fuels are subjected to hydrotreatment methods: hydrodesulphurisation by the action of hot hydrogen at 350° C. and under pressure (50 to 100 bar and more), with catalyst, with the aim of removing the sulphur compounds they naturally contain. This removal of the sulphur compounds leads to a loss of the lubricating power of the fuels obtained.

However, fuels, of diesel and gasoline type, and fuels intended for aviation must have lubrication properties for the protection of pumps, injection systems and all the moving parts with which these products are in contact in an engine, in particular an internal combustion engine. Additives must then be added to these fuels in order to restore their lubricating power.

It is known to use fatty acids as lubricity additives. In general, the fatty acids used are produced by fractionating vegetable or animal oils. For example, Tall Oil Fatty Acids or TOFA are known to have good lubricity properties in low sulphur gas oils (W09804656). These fatty acids generally have a high acid number. The gain in the improvement of lubricity is significant at low dosage but tends to reach a plateau as the dosage increases.

It is moreover known to use mono-glycerides and di-glycerides as lubricity additives. Mono- and di-glycerides are partial esters produced from the reaction between fatty acids and glycerol (in excess). They have a very low acid number: this is referred to as neutral lubricity. However, the improvement in lubricity is generally not immediate at low dosages, requiring the use of large amounts, which increases the cost of treatment.

It is also known to use neutralisation pastes obtained by acidifying at least one vegetable and/or animal oil. However, these acid oils obtained may have high triglyceride levels, which have only a limited effect on lubricity. In addition, this acidification is expensive in terms of equipment, in particular due to the alkaline neutralisation, is not ecological because a lot of water/steam and electricity are required. In addition, a lot of waste remains after this chemical refining and large amounts of alkaline agent (soda) are used.

Existing diesel solutions are unsatisfactory, too expensive and wasteful in energy, water and installation investment, and resulting in too much waste produced; and few existing gasoline solutions, there remains a need to find new lubricity additives for fuel, in particular for internal combustion engines, in particular for fuels of diesel or gasoline type, which are inexpensive, effective, use little equipment and few chemical compounds, and which recover waste.

### OBJECT OF THE INVENTION

The applicant has discovered that a particular additive, containing sterols and free fatty acids, and as described below, has remarkable and unexpected properties in liquid fuels for internal combustion engines. Such additive guarantees and improves the lubricating power of fuels.

The additional advantages of the fuel additive according to the invention are:
the protection of pumps, injection systems and all moving parts with which this additive is in contact in an engine,
an optimal engine operation,
a saving due to less engine maintenance,
a reduced fuel consumption,
the recovery of waste from the distillation of oils,
the low cost of this additive.

The object of the present invention is thus an engine fuel composition comprising:

(1) at least one liquid hydrocarbon fraction from one or more sources selected from the group consisting of mineral, animal, plant and synthetic sources, and

(2) from 1 to 10,000 ppm by weight of an additive which comprises at least 6% by weight, in relation to the total weight of the additive, of one or more compounds selected from free sterols and/or sterol esters and from 70% to 94% by weight, in relation to the total weight of the additive, of free fatty acids.

According to one embodiment, this additive is obtained from a method for refining one or more vegetable and/or animal oils, and in particular is obtained from a deodorisation operation of one or more vegetable and/or animal oil(s), which consists in a distillation, or neutralising distillation, of said oils, allowing to obtain deodorisation discharge. Products from oil deodorisation are also known as “deodoriser distillates”.

Preferably, the liquid hydrocarbon fraction (1) is selected from gasolines and diesel fuels.

Preferably, the content of the additive ranges from 5 to 10,000 ppm by weight, preferably from 10 to 1000 ppm by weight, more preferably from 25 to 500 ppm by weight, and even more preferably from 150 to 250 ppm by weight, in relation to the total weight of the fuel composition.

Preferably, the sulphur content in the fuel composition is less than or equal to 5000 ppm by weight, preferably less than or equal to 500 ppm by weight, and more preferably less than or equal to 50 ppm by weight, even more preferably less or equal to 10 ppm by weight in relation to the total weight of the composition.

The invention also relates to the use, to improve the lubricity properties of an engine fuel, of an additive which comprises at least 6% by weight, in relation to the total weight of the additive, of one or more compounds selected from free sterols and/or sterol esters and from 70% to 94% by weight, in relation to the total weight of the additive, of free fatty acids.

Other objects, features, aspects and advantages of the invention will appear even more clearly upon reading the description which follows.

In what follows, and unless otherwise indicated, the limits of a range of values are comprised in this range, in particular in the expressions “comprised between” and “ranging/ranges/extends from . . . to . . . ”. Moreover, the expressions “at least one” and “at least” used in the present description are respectively equivalent to the expressions “one or more” and “greater than or equal”.

### DETAILED DESCRIPTION

The additive

The invention uses one or more additives comprising at least 6% by weight of free sterols and/or sterol esters and from 70% to 94% by weight of free fatty acids, these contents being expressed in relation to the total weight of the additive.
i) Preferably, the additive according to the invention comprises at least 2% by weight of sterol ester(s) and at least 4% by weight of free sterol(s) in relation to the total weight of the additive, preferably at least 2.3% by weight of sterol ester(s) and at least 4.5% by weight of free sterol(s) in relation to the total weight of the additive.
ii) Preferably, the additive comprises at least 80% by weight of free fatty acids, in relation to the total weight of the additive.
iii) Preferably, the additive has a content by weight of C18:1 and C18:2 free fatty acids greater than or equal to 30% by weight, preferably greater than or equal to 50% by weight, preferably greater than or equal to 70% by weight, in relation to the total weight of the additive.
iv) Preferably, the additive has a pour point less than or equal to 0° C., according to standard ASTM D 7346.
v) According to one embodiment, the additive has a content of free fatty acids containing two unsaturations which is less than or equal to 25% by weight in relation to the total weight of the additive, preferably less than or equal to 22% by weight, preferably less than or equal to 21% by weight, preferably comprised between 19% and 20% by weight.
vi) According to one embodiment, the additive comprises from 50 to 65% by weight of monounsaturated free fatty acids, and from 20 to 30% by weight of polyunsaturated free fatty acids in relation to the total weight of fatty acids; it may also comprise from 5 to 14% by weight of saturated free fatty acids in relation to the total weight of fatty acids.
vii) Preferably, the additive comprises a content by weight of tocopherol(s) of at least 1% by weight in relation to the total weight of the additive, preferably of at least 1.5% by weight, preferably at least 2% by weight, even more preferably at least 2.5% by weight, even more preferably at least 2.8% by weight, in relation to the total weight of the additive.

The additive according to the invention may also advantageously have one or more of the following features:
viii) a content by weight of monoglycerides and/or diglycerides from 0.001 to 15% by weight, or from 0.5% to 5% by weight, even more preferably from 0.8% to 3% by weight, in relation to the total weight of the additive;
xi) a content by weight of triglycerides from 0 to 13% by weight, from 0 to 12%, preferably from 0 to 10%, preferably from 0 to 7%, even more preferably from 0 to 5%, or even 0.01%, in relation to the total weight of the additive;
x) a pour point less than or equal to +6° C., preferably less than or equal to 0° C., preferably less than or equal to −3° C., preferably less than or equal to −6° C., preferably less than or equal to −9° C., preferably less than or equal to −12° C., preferably less than or equal to −15° C., preferably less than or equal to −18° C., according to standard ASTM D 7346;
xi) a content by weight of total sterols (free sterol(s) and sterol ester(s)) of at least 6%, or of at least 7% by weight, or preferably of at least 8% by weight, in relation to the total weight of the additive.

Advantageously, the lubricity additive present in the fuel composition according to the invention may have all the features i) to xi) previously described or a combination of two or more of these features, for example: vii)+i), vii)+viii), vii)+viii)+ix), i)+ii)+iii), i)+ii), i)+ii)+vi), i)+ii)+v), i) +ii)+iv) i)+vii), i)+vii)+viii), i)+vii)+viii)+ix), etc.

The free fatty acids of the additive, according to the invention, usually have C₁₄-C₂₄, preferably C₁₆-C₂₀ carbon chains.

The free fatty acids are mainly: myristic 14:0, palmitic 16:0, palmitoleic 16:1, stearic 18:0, oleic 18:1, linoleic 18:2 (n-6), linolenic 18:3 (n-3), arachidic 20:0, gondonic 20:1, behenic 22:0, erucic 22:1, lignoceric 24:0, nervonic 24:1 acids.

Advantageously, the additive comprised in the fuel composition according to the invention comprises between 75% and 94% by weight of free fatty acids, between 0 and 2% by weight of monoglycerides, between 0 and 3% by weight of diglycerides, from 0 to 7% by weight of triglycerides, at least 6% by weight, or even at least 7% by weight of total sterol(s). These contents are expressed in relation to the total weight of the additive.

In another embodiment, the additive comprised in the fuel composition according to the invention comprises between 75% and 92.999% by weight of free fatty acids, between 0.0005 and 2% by weight of monoglycerides, between 0.0005 and 3% by weight of diglycerides, from 0 to 7% by weight of triglycerides, at least 6% by weight, or even at least 7% by weight of total sterol(s), and at least 1% by weight of tocopherol(s), or even 1.5% by weight, in relation to the total weight of the additive.

The fatty acids present in the additive according to the invention can be in free or non-free form. In a manner known per se, non-free fatty acids denote fatty acids covalently bonded to other molecules, in particular esterified fatty acids in the form of mono-, di- or tri-glycerides.

Method for obtaining the additive by physical refining

According to one embodiment, the additive of the invention is obtained from a method for refining one or more vegetable and/or animal oil(s), which consists in a distillation of these oils without alkaline chemical treatment (without addition of base) and comprising a deodorisation step, hereinafter referred to as “physical refining” in the present application.

The physical refining of vegetable and/or animal oils, that is to say the distillation of these crude oils, mainly used in the case of little fluid/viscous oils (palm, palm kernel, . . . ), allows to separate the different components thereof, in particular thanks to a deodorisation step: phospholipids, pigments, waxes, free fatty acids and glycerides (mono, di- and tri-glycerides), lipids, . . . This method is typically used in the treatment of oils intended for human food.

The compounds obtained by this distillation, hitherto considered as waste, are thus mixtures of active materials at low cost. The present invention allows to advantageously recover these products.

The applicant has discovered that it is possible to obtain the additive according to the invention by a method of physical refining of at least one vegetable and/or animal oil. The additive according to the invention is thus obtained only from biomass and henceforth recovered, considered until now as a waste from these distillations.

Physical refining comprises a “deodorisation” step, which removes all (volatile) compounds unsuitable for food: free fatty acids, sterols, oxidation products, unpleasant aromas/odour compounds, dyes, toxic products (pesticides, glycosides, . . . ), phospholipids and other impurities such as metals (iron, copper, . . . ). This physical refining is adapted for oils with a low phospholipid content, little fluid (palm, palm kernel, copra, tallow, lard, . . . ) and containing more than 3% by weight of free fatty acids.

Typically, the method of physical refining or “neutralising distillation” of crude animal and/or vegetable oils comprises six steps:
(a) demucilagination or degumming,
(b) washing then drying,
(c) bleaching,
(d) filtration,
(e) deodorisation,
(f) inerting.

(a) Demucilagination or degumming this is an acid conditioning with water and a (phosphoric) acid at 0.05-1% by weight, to remove compounds capable of becoming insoluble by hydration, such as phospholipids, lipoproteins... or capable of being removed with the aqueous phase (carbohydrates). There is removal of phospholipids by formation of micelles, rapid hydration of phospholipids, then removal of non-hydratable phospholipids by treatment with acids.

(b) Washing followed by centrifugation: this step allows to remove the last traces of metals, phospholipids and other impurities (polar oxidation products and some contaminants). Washing is most effective when done in two stages, and the washing water should be as hot as possible (90° C.). Moisture present in the washed oil is removed before the bleaching operation as it can cause rapid clogging of the filters.

(c) bleaching: this operation aims at removing the pigments from the oil (chlorophyll and carotenoid pigments), which are harmful to its colour and its conservation. During this step, primary and secondary oxidation products, metals, soaps, phosphatidic and polyaromatic compounds as well as tocopherols are also adsorbed. To this end, the oil previously heated above 100° C. and dehydrated is treated with activated carbon or another adsorbent. The bleaching agents used are:
bleaching earths: natural earths or fuller's earths (or smectic clay) are used as they are because they have a natural bleaching power. These are plastic clays which are generally simply dried and finely ground to increase the contact surface. Studies have shown that their activity is very good with respect to carotenes, chlorophylls, aldehydes and ketones,
activated carbons: activated carbons contain 95 to 98% carbon, and their specific character comes from their porosity. The activation is carried out chemically, under the action of low-volatile oxygenated acids, phosphoric acid, zinc chloride, potassium carbonates, or by gas activation by air, steam or carbon dioxide (CO₂). Activated carbons allow to remove polycyclic aromatic hydrocarbons which may be present in significant amounts in some vegetable oils.

(d) filtration: a dewaxing and a filtration allows to remove waxes and bleaching earths. Complete removal of bleaching earth from oil by filtration is very important because the clay residue acts as a strong oxidant and fouls downstream equipment. The filters usually used after bleaching implement filtering surfaces most often made up of metal gauzes (example: Niagara filter when it comes to continuous installation).

(e) deodorisation: as the name suggests, it aims at removing volatile substances such as aldehydes and ketones, which give an unpleasant odour and flavour to the oil, as well as free fatty acids still present, some of which are very sensitive to oxidation.

It is a stripping (entrainment of gas or volatile products dissolved in water by the action of another gas, by carrying out a desorption)/distillation operation, with entrainment with steam, injected at low pressure (under vacuum) and at high temperature to vaporise/evaporate the free fatty acids: indeed, during physical refining, the fatty acids are not removed by neutralisation unlike chemical refining.

This operation consists in distilling the oil with the injection of dry steam (from 180 to 260° C., preferably 230-250° C., or a “flash” distillation: 260° C.), under vacuum (1-10 mbar, preferably 1-2 mbar). This step allows to avoid oxidation of the oil and to collect free fatty acids, volatile compounds, hydroperoxides, contaminants (pesticides, light polycyclic aromatics, . . . ), and unsaponifiables (tocopherols, sterols, sterol esters . . . ).

Prolonged heating at high temperature should be avoided as it may cause polymerisation. Furthermore, the absence of air is imperative, antioxidants are sometimes added as well as some salts (citrates, phosphates, tartrates) which complex the traces of copper and iron metals, which may be present.

The distillation can be continuous, semi-continuous or fractionated, with different kinds of columns: horizontal, vertical, with plates, on a packed column, etc.

Continuously, it is carried out in cylindrical towers where the oil enters from the upper part and descends through a series of discs, or columns, where the sweep gas circulates in counter-current, from bottom to top. This process has a considerable saving of steam and heat by using the hot oil which leaves through the lower part of the column to heat the bleached oil which enters through the upper part.

(f) At last, inerting allows to collect a refined oil, resulting from the “physical” refining of these oils: using gaseous nitrogen, carbon dioxide, argon, for example, to prevent oxidation of the oil.

The physical refining method has the advantages of consuming little water, few chemicals, being simple to implement, giving good stability to the isolated products, and having a higher yield than the chemical refining method.

Chemical refining method, comparison

A conventional chemical refining method comprises the following steps:
demucilagination or degumming removal of mucilage (vegetable substances, consisting of polysaccharides) with water or acid solutions (phosphoric or citric acids),
neutralisation: neutralisation of free fatty acids by adding a basic composition, in particular a solution of sodium hydroxide.

The oil leaves the demucilagination turbine at 60° C.-80° C. and passes through a plate heat exchanger which raises the temperature to around 90° C. The neutralising solution is then injected by a metering pump system. The amount of soda is generally in slight excess, 5 to 10% above the amount calculated for the complete neutralisation of the free fatty acids and the phosphoric acid present in the oil. The mixture of oil and soda passes through a rapid mixer or a static mixer before being sent to the centrifuge intended to separate the neutralisation pastes.

### Advantages of Physical Refining

Physical refining allows to obtain volatile compounds and free fatty acids through deodorisation, at high temperature and low pressure. All of the free fatty acids are separated during deodorisation using steam, under high pressure: this is what differentiates, in the first place, the additives obtained by this physical refining from the products obtained by the chemical refining of these oils, whereby the majority of the free fatty acids are separated by neutralisation with soda (giving the neutralisation pastes which can then be acidified to give acidic oils).

In addition, by using this particular physical refining method, the additives obtained contain a higher amount of free fatty acids (more than 70% by weight) compared to the amount of product obtained by chemical refining of the oils (30-50% by weight in general for the chemical refining) and a higher amount of sterol(s).

The product obtained by physical refining as described above is therefore different from a product which would be obtained by chemical refining of the same starting oil.

In one embodiment, the additive according to the invention may thus be the volatile fraction obtained during a deodorisation step of the physical refining of an oil.

The additive consists of free fatty acids and mono- and di-glycerides (degraded triglycerides, glycerol esters), free sterols, sterol esters and tocopherols (vitamin E: α-tocopherol, β-tocopherol, γ-tocopherol, δ-tocopherol) (unsaponifiables).

Mono- and di-glycerides, partial glycerides, are glycerol esters.

Sterols are lipids with a sterane nucleus whose carbon 3 carries a hydroxyl group, they are a subclass of steroids, present in some vegetables.

The preferred method for obtaining the additive according to the invention preferably comprises steps a) to e) described above.

The deodorisation discharge collected in step e), generally have a water content less than or equal to 1% by weight, preferably less than or equal to 0.5% by weight, preferably less than or equal to 0.3% by weight, in relation to the total weight of the composition.

The distillation is carried out at a temperature comprised between 220° C. and 280° C. preferably under high vacuum, preferably between 230° C. and 260° C., preferably under high vacuum, preferably between 230° C. and 250° C. preferably under high vacuum, preferably at 260° C. preferably under high vacuum.

According to this embodiment, the additives of the invention are therefore products derived from biomass. Advantages associated with such additives reside, on the one hand, on their low cost of implementation, and, on the other hand, on the absence of undesirable toxic substances, such as pesticides, aflatoxin, heavy metals, dioxin and furan precursors, PCBs (polychlorinated biphenyls) and nitrites.

Vegetable and/or Animal Oil used in the Physical Refining Method

When the additive is obtained from a method of physical refining of an oil, the starting oil is an organic, lipid product insoluble in water and soluble in organic (rather apolar) solvents, containing less than 0.1% by weight of water.

Oils typically consist of 95 to 99% by weight of triglycerides (a)' (including 90-95% of fatty acids, and 3-5% of glycerol), and natural constituents in minor amounts: phytosterols, tocopherols, phospholipids which themselves consist of two kinds of compounds, called unsaponifiables (b′) (0.1-3% by weight) and polar lipids (c′) (0.1-0.2% by weight):
(a′) The free fatty acids can be obtained by distillation of at least one vegetable and/or animal oil, such as, without limitation, sunflower oil, soybean, rapeseed, linseed, palm, palm kernel, coconut palm (copra), cocoa, cotton, peanut, olive, walnut, grape, corn, wheat, fish oil, beef tallow, lard, duck fat.
(b)′ Five main groups of substances are present in most of the unsaponifiables of vegetable and/or animal oils: saturated or unsaturated hydrocarbons, aliphatic alcohols (fatty alcohols . . . ) or terpenes, sterols, tocopherols, squalene, terpene alcohols, carotenoid pigments (carotenes . . . ) and xanthophiles. The unsaponifiables are compounds which constitute the fraction of a fatty substance which, after prolonged action of an alkaline base (potash for example), remains insoluble in water and can be extracted by an organic solvent.
(c′) Polar lipids comprise, in turn, phospholipids, glycolipids, sphyngolipids.

Degradation products (oxidation, hydrolysis, thermal degradation), contaminants (metals, plant protection products, dioxins, polycyclic aliphatic hydrocarbons (PAH), solvents, . . . ) and undesirables (water, impurities, proteins . . . ) are also present in oils, in negligible amounts.

These vegetable and/or animal oils typically comprise a very large majority of saturated or unsaturated C₁₆-C₁₈ carbon chains among which preferably unsaturated C₁₈ carbon chains, but also in a smaller amount of C₂₀-C₂₄, C₁₀-C₁₄ or even C₄-C₈ chains. Vegetable oils usually comprise palmitic, stearic, oleic, linoleic, linolenic acid, and other acids in smaller amounts (caprylic, butyric, lauric, palmitoleic, arachidic, behenic, gadoleic . . . ).

The crude animal and/or vegetable oil treated in step a) of the refining can be a mixture of different vegetable and/or animal oils.

According to a preferred embodiment, the additive according to the invention is only obtained from one or more vegetable oils. In other words, it is obtained directly from the distillation of at least one vegetable oil.

Fuel composition

The object of the present invention is in particular a fuel composition comprising:
(1) at least one liquid hydrocarbon fraction from one or more sources selected from the group consisting of mineral, animal, plant and synthetic sources, and
(2) from 1 to 10,000 ppm by weight of an additive which comprises at least 6% by weight of free sterols and/or sterol esters in relation to the total weight of the additive and from 70% to 94% by weight , in relation to the total weight of the additive, of free fatty acids.

Petroleum will preferably be selected as the mineral source.

The liquid hydrocarbon fraction is advantageously selected from hydrocarbon fuels and non-essentially hydrocarbon fuels, alone or as a mixture.

Hydrocarbon fuel means a fuel consisting of one or more compounds consisting only of carbon and hydrogen. Gasoline and gas oil (also called diesel fuel) are hydrocarbon fuels.

The term “non-essentially hydrocarbon fuel” means a fuel consisting of one or more compounds consisting not essentially of carbon and of hydrogen, that is to say which also contain other atoms, in particular oxygen atoms.

According to a particular embodiment, the fuel composition may comprise at least one hydrocarbon fuel selected from middle distillates with a boiling point comprised between 100 and 500° C., preferably 150 to 450° C., preferably 190 to 400° C., preferably 210 to 350° C., preferably 220 to 330° C., or lighter distillates having a boiling point comprised between 50 and 210° C., lighter distillates being able to be transformed (or not) in conversion units such as (but not limited to): catalytic reforming, isomerisation or catalytic cracking and constituting the gasoline range.

These middle distillates can, for example, be selected from distillates obtained by direct distillation of crude hydrocarbons, vacuum distillates, hydrotreated distillates, distillates resulting from catalytic cracking and/or vacuum hydrocracking of distillates, distillates resulting from ARDS-type conversion methods (by desulphurisation of atmospheric residue).

The fuels/fuel composition may comprise at least one liquid hydrocarbon fuel selected from gas oils, diesel fuels, gasolines, biofuels, jet fuels, domestic heating oils (DHO) and heavy fuel oils, preferably gas oils (or diesel fuels), or gasolines.

Hydrocarbon fuels are typically gasoline and gas oils (also called diesel fuel).

Advantageously, the liquid hydrocarbon fraction is selected from gasolines and diesel fuels.

Fuels may also contain new sources of distillates, among which mention may be made of:
the heaviest fractions from cracking and visbreaking methods concentrated in heavy paraffins, comprising more than 18 carbon atoms,
synthetic distillates resulting from the transformation of gas such as those resulting from the Fischer Tropsch method,
synthetic distillates resulting from the treatment of biomass of vegetable and/or animal origin, such as in particular BTL (acronym for the term biomass to liquid) of vegetable and/or animal biomass, and/or mixtures thereof (not essentially hydrocarbon fuel),
vegetable and/or animal oils and/or their esters, preferably fatty acid methyl esters (FAME) or fatty acid ethyl esters (FAEE), in particular vegetable oil methyl esters (VOME) or vegetable oil ethyl esters (VOEE) (not essentially hydrocarbon fuel),
hydrotreated (HVO) and/or hydrocracked and/or hydrodeoxygenated (HDO) vegetable and/or animal oils (not essentially hydrocarbon fuel),
biodiesels of animal and/or vegetable origin (not essentially hydrocarbon fuel).

More specifically, gas oils (Diesel fuels) comprise, in particular, all commercially available Diesel engine fuel compositions. Mention may be made, by way of representative example, of diesel fuels complying with standard NF EN 590.

Gasolines comprise, in particular, any commercially available spark ignition engine fuel compositions. Mention may be made, by way of representative example, of the gasolines complying with standard NF EN 228. The gasolines generally have sufficiently high octane numbers to avoid the knocking phenomenon. Typically, gasoline-type fuels marketed in Europe, in accordance with standard NF EN 228, have a Motor Octane Number (MON) greater than 85 and a Research Octane Number (RON) of a minimum of 95. Gasoline-type fuels generally have a RON ranging from 90 to 100 and a MON ranging from 80 to 90, the RON and MON being measured according to standard ASTM D 2699-86 or D 2700-86.

The fuel can also be a mixture of hydrocarbon fuel and non-essentially hydrocarbon fuel, which are typically Bx-type diesel fuels and Ex-type gasolines.

Bx-type diesel fuel for Diesel engines means diesel fuel which contains x % (v/v) of biofuels, generally esters of vegetable or animal oils (including used cooking oils) transformed by a chemical method called transesterification, obtained by reacting this oil with an alcohol in order to obtain fatty acid esters (FAE). With methanol and ethanol, respectively, fatty acid methyl esters (FAME) and fatty acid ethyl esters (FAEE) are obtained. The letter “B” followed by a number indicates the percentage of FAE contained in the fuel. For example, a B99 contains 99% FAE and 1% middle distillates of fossil origin (mineral source), B20, 20% FAE and 80% middle distillates of fossil origin etc. Therefore, it is possible to distinguish B0-type diesel fuels which do not contain oxygenated compounds, Bx-type diesel fuels which may contain said oxygenated compounds if the biofuel used is an ester of vegetable oils or fatty acids, most often methyl esters (VOME or FAME). When FAE is used alone in engines, the fuel is referred to as B100.

Ex-type gasoline for spark ignition engines means a gasoline fuel which contains x% (v/v) of oxygenates, generally ethanol, bioethanol and/or ethyl-tertio-butyl-ether (ETBE).

The fuel composition can only comprise new sources of distillates (which generally comprise, for diesel fuels, long paraffinic chains greater than or equal to 10 carbon atoms and preferably from C₁₄ to C₃₀) or be composed of a mixture with conventional petroleum middle distillates as a diesel-type fuel base or a mixture with conventional petroleum-based lighter distillates as a gasoline-type fuel base. These new sources of

The additive according to the invention is preferably present in a small amount in the fuel composition according to the invention, in a content sufficient to produce a lubricating effect.

Preferably, the fuel composition comprises the additive(s) according to the invention in a minimum content of 5 ppm by weight, in relation to the total weight of the fuel composition.

Preferably, the content of the additive ranges from 5 to 10,000 ppm by weight, preferably from 10 to 1000 ppm by weight, more preferably from 25 to 500 ppm by weight, and even more preferably from 150 to 250 ppm by weight, in relation to the total weight of the fuel composition.

Preferably, the sulphur content in the fuel composition is less than or equal to 500 ppm by weight, and preferably less than or equal to 50 ppm by weight, even more preferably less than or equal to 10 ppm by weight, in relation to the total weight of the composition, and advantageously without sulphur.

### Fuel Composition Additives

The fuel composition may also comprise one or more additional additive(s), different from said additives according to the invention.

This or these additional additive(s) may for example be selected, in a non-limiting manner, from: detergent additives, anti-corrosion agents, dispersants, demulsifiers, anti-foaming agents, biocides, reodorants, procetane additives, friction modifiers, lubricity additives or oiliness additives, combustion aid agents (catalytic combustion and soot promoters), cold resistance additives and in particular agents improving the turbidity, pour point, FLT (“Filterability Limit Temperature”), anti-sedimentation agents, anti-wear agents and conductivity modifying agents.

This or these additional additive(s) are more preferably selected from:
a) procetane additives, in particular (but not limited to) selected from alkyl nitrates, preferably 2-ethyl hexyl nitrate, aryl peroxides, preferably benzyl peroxide, and alkyl peroxides, preferably tert-butyl peroxide;
b) antifoam additives, in particular (but not limited to) selected from polysiloxanes, oxyalkylated polysiloxanes, and fatty acid amides from vegetable or animal oils. Examples of such additives are given in EP861882, EP663000, EP736590;
c) Cold Flow Improvers (CFI) selected from copolymers of ethylene and unsaturated ester, such as ethylene/vinyl acetate (EVA), ethylene/vinyl propionate (EVP), ethylene/vinyl ethanoate (EVE), ethylene/methyl methacrylate (EMMA), and ethylene/alkyl fumarate copolymers described, for example, in the documents U.S. Pat. Nos. 3,048,479, 3,627,838, 3,790,359, 3,961,961 and EP261957;
d) lubricity additives or anti-wear agents, in particular (but not limited to) selected from the group consisting of fatty acids and their ester or amide derivatives, in particular glycerol monooleate, and derivatives of carboxylic mono- and polycyclic acids. Examples of such additives are given in the following documents: EP680506, EP860494, WO98/04656, EP915944, FR2772783, FR2772784;
e) cloud point additives, in particular (but not limited to) selected from the group consisting of long chain olefin/(meth)acrylic ester/maleimide terpolymers, and polymers of fumaric/maleic acid esters. Examples of such additives are given in FR2528051, FR2528051, FR2528423, EP112195, EP172758, EP271385, EP291367;
f) detergent additives, in particular (but not limited to) selected from the group consisting of succinimides, polyetheramines and quaternary ammonium salts; for example those described in documents U.S. Pat. No. 4,171,959 and WO2006135881;
g) polyfunctional cold operability additives selected from the group consisting of olefin and alkenyl nitrate-based polymers as described in EP573490.

These additional additives may be present in amounts ranging from 10 to 1000 ppm (each).

### Uses

Another object of the invention is the use, to improve the lubricity properties of an engine fuel, of an additive which comprises at least 6% by weight of one or more compounds selected from free sterols and/or sterol esters in relation to the total weight of the additive and from 70% to 94% by weight, in relation to the total weight of the additive, of free fatty acids.

The lubricity properties of an additive are defined according to standard ISO 12156-1 for diesels. This standard can be used for gasoline with the use of an adapted kit.

Advantageously, the additive content of the fuel composition is sufficient for the fuel composition to have a lubricating power less than or equal to 460 μm, preferably less than or equal to 430 μm, preferably less than or equal to 397 μm, under the conditions of the HFRR (High Frequency Reciprocating Rig) test as described in the article SAE 932692 by J.W. HADLEY of the University of Liverpool or in standard ISO 12156-1 for diesel standard that can be applied to gasoline.

Preferably, the additive is as defined previously according to the features i) to xi) and in the paragraph “additive”.

Advantageously, the engine fuel lubricity additive contains between 70% and 92.999% by weight of free fatty acids, between 0.0005 and 2% by weight of monoglycerides, between 0.0005 and 3% by weight of diglycerides, from 0 to 7% by weight of triglycerides, at least 6% by weight, even at least 7% by weight of sterol(s), and at least 1% by weight, even 1.5% by weight, of tocopherol(s), in relation to the total weight of the additive.

According to one embodiment, this additive is obtained from a method for refining one or more vegetable and/or animal oils.

Preferably, the additive content in the fuel composition ranges from 5 to 10,000 ppm by weight, preferably from 10 to 1000 ppm by weight, more preferably from 25 to 500 ppm by weight, and even more preferably from 150 to 250 ppm by weight, in relation to the total weight of the fuel composition.

Preferably, the additive is used in a diesel fuel composition, preferably having a sulphur content less than or equal to 50 ppm, or even 10 ppm, by weight in relation to the total weight of the composition, advantageously without sulphur.

### Method for Preparing the Fuel Composition

The fuel composition according to the invention can be prepared according to any known method, by adding a liquid hydrocarbon fraction as described above with at least one additive as described above, and optionally one or more other additives different from the additive according to the invention, as described previously.

Advantageously, before its use and mixing with a fuel composition, the additive can undergo one or more treatment steps selected from centrifugation, filtration, precipitation. In particular, a centrifugation step can allow to obtain a water content less than or equal to 1% by weight, or even less than or equal to 0.8% by weight, in particular from 0.1% to 0.7% by weight.

In addition to the removal of water, collected in an aqueous phase, the centrifugation can also allow the removal of part of the solid residues in suspension.

### Method for Improving Lubricity

The invention also relates to a method for improving the lubricity of a fuel composition for an internal combustion engine comprising a step during which at least one additive as described above is added to a fuel composition, which may be obtained, in one embodiment, via a physical refining method, preferably distillation, which may be under vacuum, of at least one vegetable and/or animal oil. The lubricity additive content of the fuel composition may be as specified above.

To explain the advantages of the present invention, examples are given below in an illustrative but non-limiting manner of the scope of the invention.

### EXAMPLES

The following notations are used:
A1 and A2: additives from the physical refining of soybean oil
FA: free fatty acids
MG: mono-glycerides
DG: di-glycerides
TG: triglycerides
AO: acid oil
TOFA: from “tall oil of fatty acid”
Cx: y, fatty acid having x carbon atoms and y unsaturations (carbon-carbon double bonds).

The lubricating power of several additives in a gas oil-type fuel for diesel engines was tested under the conditions of the HFRR (High Frequency Reciprocating Rig) test as described in the article SAE 932692 by J.W. HADLEY of the University of Liverpool or standard ISO 12156-1. This standard can be used for gasoline with the use of an adapted kit.

This lubricating power can thus be defined as the property of a liquid determined by measuring the wear mark produced by the contact of an oscillating ball on a fixed plate immersed in the liquid and under tightly controlled conditions.

The test consists in jointly imposing on a steel ball in contact with a stationary metal plate, a pressure corresponding to a weight of 200 g and an alternating displacement of 1 mm at a frequency of 50 Hz. The moving ball is lubricated by the composition to be tested. The temperature is maintained at 60° C. (for gas oils and 25° C. for gasoline) throughout the duration of the test, that is to say 75 minutes. The lubricating power is expressed by the average value of the diameters of the wear mark of the ball on the plate. The smaller the wear diameter, the better the lubricating power. Generally, a wear diameter less than or equal to 460 μm±63 μm is required for a gas oil-type fuel.

A lubricant is considered to be better than another and therefore has improved lubricating properties when the HI-RR difference is at least 63 μm, according to standard ISO12156-1.

The features of the gas oil tested are gathered in Table 1 below.

TABLE 1

| | Gas oil | Standard | Unit |
|---|---|---|---|
| Kinematic viscosity at 40° C. | 33.04 | NF EN3104 | mm²/s |
| (VC40) | | | |
| Filterability Limit Temperature | −15 | NF EN 116 | ° C. |
| Cloud point | −15 | ASTM D7689 | ° C. |
| Density at 15° C. | 823.7 | NF EN ISO 12185 | kg/m³ |
| Sulphur content | <3.0 | EN ISO20846 | mg/kg |
| | | EN ISO20884 | |
| Acid number | <0.01 | NF ISO 6618 | mgKOH/g |
| Aromatic content | 14.1 | GCxGC | % |
| Polyaromatic content | 1.2 | GCxGC | % |
| Measured cetane number | 57.8 | ASTM D613 | NF |
| Calculated cetane number | 64.6 | ISO 4264 | NF |
| Flash point | 102 | ASTM D93 | ° C. |
| Water content | 22 | ASTM E1064 | mg/kg |
| HFRR | 636 | ISO 12156-1 | μm |
| Distillation | | ASTM D86 | ° C. |
| 0% | 227.0 | | |
| 5% | 241.9 | | |
| 10% | 247.7 | | |
| 20% | 257.0 | | |
| 30% | 265.8 | | |
| 40% | 274.5 | | |
| 50% | 283.0 | | |
| 60% | 290.4 | | |
| 70% | 297.7 | | |
| 80% | 305.5 | | |
| 85% | 310.0 | | |
| 90% | 315.5 | | |
| 95% | 324.1 | | |
| 100% | 328.8 | | |

Various additives, hereinafter referred to as A1, A2, TOFA and AO, were added to this gas oil in a content of 200 ppm by weight, and an HFRR test was carried out for each additive in order to determine its lubricating power.

The additives A1 and A2 are in accordance with the invention and are directly obtained from a method of physical refining of vegetable soya oils.

The TOFA additive (comparison 1) is obtained conventionally by simple distillation of tall oil.

The AO additive (comparison 2) is obtained from rapeseed oil, by treatment with a basic solution (neutralisation), extraction of the neutralisation paste containing the esters and re-acidification of the latter to obtain the free fatty acids.

Table 2 below details the composition of the additives A1 and A2, as well as comparative examples TOFA and AO. Table 3 shows their detailed fatty acid composition, as well as their pour point.

TABLE 2

| | A1 | A2 | TOFA | AO |
|---|---|---|---|---|
| Total free FA (% weight) | 75.9 | 70.4 | 95.8 | 54.7 |
| MG (% weight) | 0.8 | 2.3 | | 0 |
| DG (% weight) | 1.7 | 8.5 | | 11.2 |
| TG (% weight) | 7 | 8 | | 31.9 |
| Sterols | 4.8 | 4.6 | | |
| Sterol esters | 2.4 | 2.1 | | 2.2 |
| Tocopherols | 2.8 | 2 | | |
| Other unidentified compounds | 4.6 | 2.1 | 4.2 | |

TABLE 3

| | A1 | A2 | TOFA | AO |
|---|---|---|---|---|
| Myristic acid 14:0 | 0.3 | 0.4 | | 4.89 |
| Pentadecylic acid 15:0 | | | | |
| Palmitic acid 16:0 | 8.1 | 8.0 | 0.2 | 5.35 |
| Palmitoleic acid 16:1 | 0.7 | 0.7 | 0.1 | 0.17 |
| Margaric acid 17:1 | 0.1 | 0.1 | | |
| Stearic acid 18:0 | 3 | 3.4 | 1.6 | 1.1 |
| Oleic acid 18:1 | 59.1 | 57.3 | 28.5 | 21.4 |
| Acid 18:2 trans | 0.2 | 0.3 | | 0.46 |
| Linoleic acid 18:2 (n-6) | 19.1 | 20.7 | 44.4 | 11.09 |
| Acid 18:3 trans | 0.3 | 0.3 | 1.0 | 0.73 |
| Linolenic acid 18:3 (n-3) | 7.2 | 6.8 | 7.7 | 2.05 |
| Arachidic acid 20:0 | 0.7 | 0.7 | 0.3 | 0.6 |
| Gondoic acid 20:1 | 0.8 | 0.9 | 1.0 | 3.45 |
| Behenic acid 22:0 | 0.2 | 0.2 | 0.2 | 2.0 |
| Erucic acid 22:1 | 0.1 | 0.1 | 0.1 | 41.75 |
| Lignoceric acid 24:0 | 0.1 | 0.1 | 0.1 | 1.85 |
| Nervonic acid 24:1 | | | 0.1 | 2.14 |
| Pour point (° C.) (standard | −15 | −15 | −12 | +3 |
| ASTM D7346) | | | | |
| VC 40° C. (mm²/s) (standard | 20 | 20 | 17 | 30 |
| NF EN 3104) | | | | |

The results of the lubricity test are gathered in Table 4 below.

The values indicated correspond to the average of the results obtained, which are comprised within an interval of ±10 μm.

TABLE 4

| Treatment rate (mg/kg | | | | |
|---|---|---|---|---|
| or ppm) | TOFA | AO | A1 | A2 |
| 0 | 615 | 615 | 615 | 615 |
| 200 | 423 | 485 | 416 | 403 |

These results show that the incorporation into the fuel composition of additives A1 or A2 according to the invention allows to reach the target of 460 μm. The technical performance is much higher than that of the acid oil AO used for comparison.

In addition, the additives A1 and A2 according to the invention are those which have the lowest pour point, which guarantees better stability at low temperature of the fuel composition containing them.

1. An engine fuel composition comprising:
(1) at least one liquid hydrocarbon fraction from one or more sources selected from the group consisting of mineral, animal, plant and synthetic sources, and
(2) from 1 to 10,000 ppm by weight of an additive which comprises at least 6% by weight, in relation to the total weight of the additive, of one or more compounds selected from free sterols and/or sterol esters and from 70% to 94% by weight, in relation to the total weight of the additive, of free fatty acids.

2. The composition according to claim 1, wherein the additive comprises at least 2% by weight of sterol ester(s) and at least 4% by weight of free sterol(s) in relation to the total weight of the additive.

3. The composition according to claim lone of claim 1, wherein the additive comprises at least 80% by weight of free fatty acids, in relation to the total weight of the additive.

4. The composition according to claim 1, wherein the additive has a pour point less than or equal to 0° C., according to standard ASTM D7346.

5. The composition according to claim 1, wherein the additive comprises a content of tocopherol(s) of at least 1% in relation to the total weight of the additive.

6. The composition according to claim 1, wherein the content of triglycerides in the additive is comprised within the range from 0 to 13% by weight, in relation to the total weight of the additive.

7. The composition according to claim 1, wherein the liquid hydrocarbon fraction (1) is selected from gasolines and diesel fuels.

8. The composition according to claim 1, wherein the content of the additive (2) ranges from 5 to 10,000 ppm by weight in relation to the total weight of the fuel composition.

9. The composition according to claim 1, wherein the sulphur content is less than or equal to 500 ppm by weight in relation to the total weight of the fuel composition.

10. A use for improving the lubricity properties of a fuel of an additive which comprises at least 6% by weight, in relation to the total weight of the additive, of one or more compounds selected from free sterols and/or sterol esters and from 70% to 94% by weight, in relation to the total weight of the additive, of free fatty acids.

11. The use according to claim 10, characterised in that the additive comprises at least 2% by weight of sterol ester(s) and at least 4% by weight of free sterol(s) in relation to the total weight of the additive.

12. The use according to claim 10, wherein the content of the additive ranges from 5 to 10,000 ppm by weight in relation to the total weight of the fuel composition.

13. The use according to claim 10, wherein the additive is used in a diesel fuel composition having a sulphur content less than or equal to 50 ppm by weight in relation to the total weight of the composition.
